(19) United States
(12) Patent Application Publication
(10) Pub. No.: US 2026/0256111 A1
(43) Pub. Date: Sep. 3, 2026

(54) TELESCOPIC PET GATE

(71) Applicant: JIANGSU ZHONGHENG PET ARTICLES JOINT-STOCK CO., LTD., Yancheng City (CN)

(72) Inventor: Bin QIU, Yancheng City (CN)

(21) Appl. No.: 19/419,246

(22) Filed: Dec. 15, 2025

(30) Foreign Application Priority Data
Feb. 28, 2025 (CN) 202520341312.2

(51) Int. Cl. A01K 1/035; E06B 9/04; E06B 9/00

(52) U.S. Cl. CPC A01K 1/035; E06B 9/04; E06B 2009/002

(57) ABSTRACT

The present disclosure relates to the field of pet supplies, and in particular, to a telescopic pet gate. The telescopic pet gate includes a gate frame, a gate panel disposed inside the gate frame, a connection assembly connected to a first end of the gate panel and to the gate frame, and a locking assembly connected to a second end of the gate panel and to the gate frame.

### CROSS REFERENCE TO THE RELATED APPLICATION

This application is based upon and claims priority to Chinese Patent Application No. 202520341312.2, filed on February 28, 2025, the entire contents of which are incorporated herein by reference.

### TECHNICAL FIELD

The present disclosure relates to the field of pet supplies, and in particular, to a telescopic pet gate.

### BACKGROUND

With the improvement of living standards, more and more people like to keep pets. However, pets are prone to getting lost, escaping or being stolen. Therefore, it is necessary to dispose barriers at the doorways or corridor entrances of pet activity areas. Pet gates have thus come into being. These gates enclose the doorways or corridor entrances, making it difficult for pets to escape or go missing.

The existing pet gates have a fixed height for confining pets during use. However, gate panels need to be added or removed according to the width of the corridor entrance or doorway to be enclosed. Moreover, the components used to secure the gate panels are often inconvenient to adjust, which results in poor practicality of these pet gates.

### SUMMARY

To solve the technical problems of the existing pet gates, such as inconvenient width adjustment and poor practicality, an objective of the present disclosure is to provide a telescopic pet gate.

To achieve the above objective, an embodiment of the present disclosure provides a telescopic pet gate, including:

a gate frame;

a gate panel, where the gate panel is disposed inside the gate frame;

a connection assembly, where the connection assembly is connected to a first end of the gate panel and to the gate frame; and

a locking assembly, where the locking assembly is connected to a second end of the gate panel and to the gate frame.

In the above technical solution, the gate frame includes:

a first vertical rod; and

a second vertical rod, where the second vertical rod is disposed at a side of the first vertical rod, and the second vertical rod is parallel to the first vertical rod.

In the above technical solution, the gate panel includes:

a first panel, where the first panel is disposed between the first vertical rod and the second vertical rod;

a second panel, where the second panel is disposed at a side of the first panel, and the second panel is disposed between the first vertical rod and the second vertical rod;

a first fixing member, where the first fixing member is connected to an upper end and/or a lower end of the first panel, and the first fixing member is U-shaped; and

a second fixing member, where the second fixing member is connected to an upper end and/or a lower end of the second panel, and the second fixing member is U-shaped.

In the above technical solution, the first panel includes:

a first barrier member; and

a second barrier member, where the second barrier member is slidably connected in the first barrier member; and

the second panel includes:

a third barrier member; and

a fourth barrier member, where the fourth barrier member is slidably connected in the third barrier member.

In the above technical solution, the connection assembly includes:

a first connecting member, where the first connecting member is connected to a side of the first vertical rod adjacent to the second vertical rod;

a second connecting member, where the second connecting member is connected to a side of the first panel adjacent to the first vertical rod; and

a third connecting member, where the third connecting member passes through the first connecting member and the second connecting member, and the third connecting member is rotatably connected to the first connecting member and the second connecting member.

In the above technical solution, the locking assembly includes:

a fourth connecting member, where the fourth connecting member is connected to a side of the second vertical rod adjacent to the first vertical rod, the fourth connecting member is U-shaped, and the fourth connecting member is provided with an opening facing the first vertical rod;

a fifth connecting member, where the fifth connecting member is connected to a side of the second panel adjacent to the second vertical rod;

a sixth connecting member, where the sixth connecting member is disposed between the second panel and the second vertical rod, and the sixth connecting member passes through the fourth connecting member and the fifth connecting member;

a first limiting member, where the first limiting member is connected to a first end of the sixth connecting member;

a second limiting member, where the second limiting member is connected to a second end of the sixth connecting member; and

a spring, where the spring is sleeved outside the sixth connecting member, and the spring is disposed between the second limiting member and the fourth connecting member.

In the above technical solution, the telescopic pet gate further includes:

a protruding portion, where the protruding portion is disposed at a bottom of the opening of the fourth connecting member, the protruding portion is provided with a sliding groove, the protruding portion is provided with a limiting hole, and the limiting hole is connected to the sliding groove; and

a third limiting member, where the third limiting member is connected to the sixth connecting member, and the third limiting member is slidably connected in the sliding groove.

In the above technical solution, the telescopic pet gate further includes:

a fourth limiting member, where the fourth limiting member is connected to the side of the second panel adjacent to the second vertical rod, and the fourth limiting member is disposed inside the fourth connecting member.

Additional aspects and advantages of the present disclosure will become apparent in the following description or will be understood through the practice of the present disclosure.

### BRIEF DESCRIPTION OF THE DRAWINGS

The above and/or additional aspects and advantages of the present disclosure will become apparent and readily comprehensible from the description of embodiments with reference to the following drawings, where

FIG. 1 is a schematic overall structural view in Embodiment 1 of the present disclosure;

FIG. 2 is a schematic front structural view in Embodiment 1 of the present disclosure;

FIG. 3 is a schematic enlarged structural view of position A in Embodiment 1 of the present disclosure;

FIG. 4 is a schematic enlarged structural view of position B in Embodiment 1 of the present disclosure;

FIG. 5 is a schematic enlarged structural view of position C in Embodiment 1 of the present disclosure;

FIG. 6 is a schematic overall schematic structural view in Embodiment 2 of the present disclosure; and

FIG. 7 is a schematic front structural view in Embodiment 2 of the present disclosure;

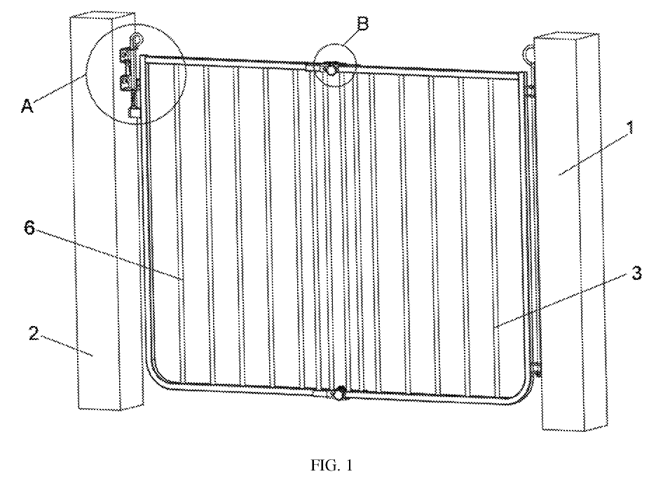

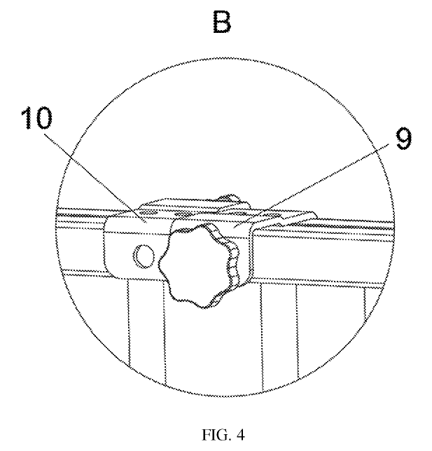

where, reference numerals in FIG. 1 to FIG. 7 are as follows:

1. first vertical rod; 2. second vertical rod; 3. first panel; 4. first barrier member; 5. second barrier member; 6. second panel; 7. third barrier member; 8. fourth barrier member; 9. first fixing member; 10. second fixing member; 11. first connecting member; 12. second connecting member; 13. third connecting member; 14. fourth connecting member; 15. fifth connecting member; 16. sixth connecting member; 17. first limiting member; 18. second limiting member; 19. spring; 20. protruding portion; 21. sliding groove; 22. limiting hole; 23. third limiting member; and 24. fourth limiting member.

### DETAILED DESCRIPTION OF THE EMBODIMENTS

To understand the above objectives, features, and advantages of the present disclosure more clearly, the present disclosure is further described in detail below with reference to the drawings and specific implementations. It should be noted that the embodiments of the present disclosure and features of the embodiments may be combined with each other in case of no conflict.

Many specific details are set forth in the following description to facilitate a full understanding of the present disclosure. However, the present disclosure can also be implemented in other ways different from those described herein. Therefore, the protection scope of the present disclosure is not limited by the specific embodiments disclosed below.

A telescopic pet gate according to some embodiments of the present disclosure is described below according to FIG. 1 to FIG. 7.

As shown in FIG. 1 to FIG. 7, an embodiment of the present disclosure provides a telescopic pet gate, including a gate frame, a gate panel, a connection assembly, and a locking assembly.

Specifically, the gate panel is rotatably connected to an inner side of the gate frame. The connection assembly is fixedly connected to a right end of the gate panel and the corresponding gate frame. The locking assembly is fixedly connected to a left end of the gate panel and the corresponding gate frame.

When the gate frame needs to be mounted, the gate frame is first pulled towards two sides according to the mounting requirement, and the gate frame drives the gate panel to move. As the gate panel can extend and retract, the widths of the gate frame and the gate panel are adjustable to accommodate doorways of different widths, thereby expanding the application range of the entire structure.

When the gate panel is in a locked state, the locking assembly connects the left end of the gate panel to the corresponding gate frame, thereby locking the gate panel. When the gate panel needs to be opened, the locking assembly is pulled upward, such that the gate panel and the gate frame are released from the locked state. Then the gate panel is pushed, and the right end of the gate panel rotates along the connection assembly. Then the gate panel is closed, and the gate panel can be locked again through the locking assembly.

In the above process, by adjusting the widths of the gate panel and the gate frame, the entire structure is applicable to doorways of different widths, which expands the application range of the entire structure. The gate panel is opened only by pulling the locking assembly upward, which achieves simple operation. In addition, after the connection assembly connects the gate panel to the gate frame, the gate panel and the gate frame can be disassembled to separate them, facilitating handling and transportation.

### Embodiment 1

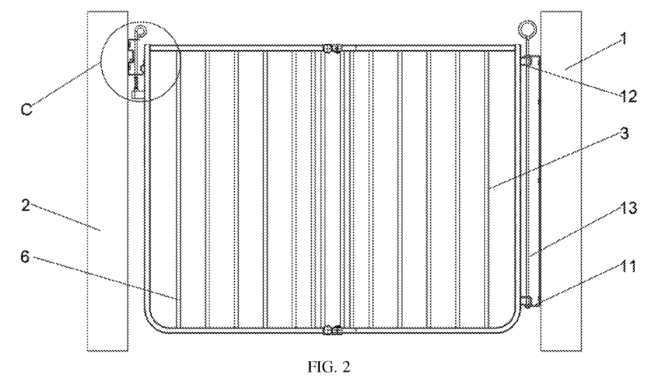

As shown in FIG. 1 and FIG. 2, in an embodiment of the present disclosure, the gate frame includes:

a first vertical rod 1; and

a second vertical rod 2, where the second vertical rod 2 is disposed at a side of the first vertical rod 1, the second vertical rod 2 is parallel to the first vertical rod 1, and the second vertical rod 2 and the first vertical rod 1 are vertically disposed.

The gate panel includes:

a first panel 3, where the first panel 3 is disposed between the first vertical rod 1 and the second vertical rod 2;

a second panel 6, where the second panel 6 is disposed at a side of the first panel 3, the second panel 6 is disposed between the first vertical rod 1 and the second vertical rod 2, the first panel 3 is parallel to the second panel 6, and the first panel 3 and the second panel 6 are not collinear;

first fixing members 9, where the first fixing members 9 are disposed at an upper left end and a lower left end of the first panel 3, respectively, the first fixing members 9 are U-shaped, the first fixing member 9 disposed at the upper left end is provided with an opening facing downward, and the first fixing member 9 disposed at the lower left end is provided with an opening facing upward; and

second fixing members 10, where the second fixing members 10 are disposed at an upper right end and a lower right end of the second panel 6, respectively, the second fixing members 10 are U-shaped, the second fixing member 10 disposed at the upper right end is provided with an opening facing downward, and the second fixing member 10 disposed at the lower right end is provided with an opening facing upward.

When the mounting of the entire structure starts, the distance between the first vertical rod 1 and the second vertical rod 2 is first determined according to the width of the doorway. Then the first vertical rod 1 and the second vertical rod 2 are pulled towards two sides. When the first vertical rod 1 and the second vertical rod 2 are pulled, since the connection assembly connects the first vertical rod 1 to the first panel 3, the first vertical rod 1 drives the first panel 3 to move to the right. Since the second vertical rod 2 is connected to the second panel 6 through the locking assembly, the second vertical rod 2 drives the second panel 6 to move to the left. Thus, through the movement of the first panel 3 and the second panel 6, the entire gate panel can meet the mounting requirement. When the positions of the first vertical rod 1 and the second vertical rod 2 are determined, the first panel 3 and the second panel 6 stop moving.

Since the first fixing members 9 are respectively disposed at the upper left end and the lower left end of the first panel 3, with the opening facing downward, the first fixing member 9 disposed at the upper left end hangs downward on the upper left end of the first panel 3 and the upper end of the second panel 6. The upper left end of the first panel 3 and the upper end of the second panel 6 are disposed inside the opening of the first fixing member 9 disposed at the upper left end. A side of the first fixing member 9 disposed at the upper left end adjacent to the first panel 3 is provided with a threaded hole. A screw is threadedly connected in the threaded hole, and an end of the screw abuts against the upper left end of the first panel 3. The screw is continuously tightened to make the first panel 3 closely attached to the second panel 6 and the second panel 6 closely attached to an inner wall of the first fixing member 9, thereby fixing the first panel 3 and the second panel 6 and avoiding relative movement between the first panel 3 and the second panel 6. The opening of the first fixing member 9 disposed at the lower left end faces upward, and the lower left end of the first panel 3 and the lower end of the second panel 6 are disposed inside the opening of the first fixing member 9. A side of the first fixing member 9 disposed at the lower left end adjacent to the first panel 3 is provided with a threaded hole. A screw is threadedly connected in the threaded hole, and an end of the screw abuts against the lower left end of the first panel 3. The screw is continuously tightened to make the first panel 3 closely attached to the second panel 6 and the second panel 6 closely attached to an inner wall of the first fixing member 9, thereby fixing the first panel 3 and the second panel 6 and avoiding relative movement between the first panel 3 and the second panel 6.

Since the second fixing members 10 are respectively disposed at the upper right end and the lower right end of the second panel 6, with the opening facing downward, the second fixing member 10 disposed at the upper right end hangs downward on the upper right end of the second panel 6 and the upper end of the first panel 3. The upper right end of the second panel 6 and the upper end of the first panel 3 are disposed inside the opening of the second fixing member 10 disposed at the upper right end. A side of the second fixing member 10 disposed at the upper right end adjacent to the second panel 6 is provided with a threaded hole. A screw is threadedly connected in the threaded hole, and an end of the screw abuts against the upper right end of the second panel 6. The screw is continuously tightened to make the second panel 6 closely attached to the first panel 3 and the first panel 3 closely attached to an inner wall of the second fixing member 10 disposed at the upper right end, thereby fixing the second panel 6 and the first panel 3 and avoiding relative movement between the second panel 6 and the first panel 3. The opening of the second fixing member 10 disposed at the lower right end faces upward, and the lower right end of the second panel 6 and the lower end of the first panel 3 are disposed inside the opening of the second fixing member 10 disposed at the lower right end. A side of the second fixing member 10 disposed at the lower right end adjacent to the second panel 6 is provided with a threaded hole. A screw is threadedly connected in the threaded hole, and an end of the screw abuts against the lower right end of the second panel 6. The screw is continuously tightened to make the second panel 6 closely attached to the first panel 3 and the first panel 3 closely attached to an inner wall of the second fixing member 10 disposed at the lower right end, thereby fixing the second panel 6 and the first panel 3 and avoiding relative movement between the second panel 6 and the first panel 3.

Through the design of the first panel 3 and the second panel 6, the gate panel formed by the first panel 3 and the second panel 6 is applicable to doorways of different widths, which expands the application range of the entire structure. The positions of the first panel 3 and the second panel 6 are fixed by the two first fixing members 9 and the two second fixing members 10, thereby avoiding relative deviation between the first panel 3 and the second panel 6.

As shown in FIG. 1 and FIG. 2, in an embodiment of the present disclosure, the connection assembly includes:

a first connecting member 11, where the first connecting member 11 is fixedly connected to a side of the first vertical rod 1 adjacent to the second vertical rod 2;

a second connecting member 12, where the second connecting member 12 is fixedly connected to a side of the first panel 3 adjacent to the first vertical rod 1; and

a third connecting member 13, where the third connecting member 13 passes through the first connecting member 11 and the second connecting member 12, the third connecting member 13 is rotatably connected to the first connecting member 11 and the second connecting member 12, and the third connecting member 13 is vertically disposed.

When the first panel 3 needs to be connected to the first vertical rod 1, the third connecting member 13 is passed through the first connecting member 11 and the second connecting member 12. Then a nut is threadedly connected to a bottom of the third connecting member 13. When the nut contacts the first connecting member 11, the connection of the first connecting member 11, the second connecting member 12, and the third connecting member 13 is completed. The first connecting member 11 and the third connecting member 13 are relatively fixed, and the second connecting member 12 is rotatable around the third connecting member 13 as an axis.

As shown in FIG. 1 to FIG. 5, in an embodiment of the present disclosure, the locking assembly includes:

a fourth connecting member 14, where the fourth connecting member 14 is fixedly connected to a side of the second vertical rod 2 adjacent to the first vertical rod 1, the fourth connecting member 14 is U-shaped, and the fourth connecting member 14 is provided with an opening facing the first vertical rod 1;

a fifth connecting member 15, where the fifth connecting member 15 is fixedly connected to a side of the second panel 6 adjacent to the second vertical rod 2, and the fifth connecting member 15 is provided with a connecting hole in a vertical direction;

a sixth connecting member 16, where the sixth connecting member 16 is disposed between the second panel 6 and the second vertical rod 2, and the sixth connecting member 16 passes through the fourth connecting member 14 and the fifth connecting member 15;

a first limiting member 17, where the first limiting member 17 is connected to an upper end of the sixth connecting member 16;

a second limiting member 18, where the second limiting member 18 is connected to a lower end of the sixth connecting member 16; and

a spring 19, where the spring 19 is sleeved outside the sixth connecting member 16, and the spring 19 is disposed between the second limiting member 18 and the fourth connecting member 14.

The telescopic pet gate further includes:

a protruding portion 20, where the protruding portion 20 is disposed at a bottom of the opening of the fourth connecting member 14, the protruding portion 20 is provided with a sliding groove 21 in the vertical direction, the protruding portion 20 is provided with a limiting hole 22, and the limiting hole 22 is connected to the sliding groove 21; and

a third limiting member 23, where the third limiting member 23 is fixedly connected to the sixth connecting member 16, and the third limiting member 23 is slidably connected in the sliding groove 21.

When the gate panel needs to be opened, the first limiting member 17 is pulled upward. The first limiting member 17 drives the sixth connecting member 16, the second limiting member 18, and the third limiting member 23 to move upward, and the third limiting member 23 moves upward along the sliding groove 21. Meanwhile, when the first limiting member 17 is pulled, since the fourth connecting member 14 is fixed and the second limiting member 18 moves upward, the second limiting member 18 compresses the spring 19. When the second limiting member 18 moves to a position above the fifth connecting member 15 and the third limiting member 23 moves to a position at the same height as the limiting hole 22, the fifth connecting member 15 and the sixth connecting member 16 no longer cooperate with each other. Then the first limiting member 17 is rotated, and the first limiting member 17 drives the third limiting member 23 to move, such that the third limiting member 23 moves into the limiting hole 22. Then the first limiting member 17 is released. Through the cooperation between the third limiting member 23 and the limiting hole 22, the sixth connecting member 16 is fixed, thereby preventing the sixth connecting member 16 from moving downward. Then the first panel 3 or the second panel 6 is pushed to open the gate panel.

When the gate panel needs to be locked, the first panel 3 and the second panel 6 are pushed back to their initial positions. Then the first limiting member 17 is rotated to make the third limiting member 23 slide out of the limiting hole 22. Then the first limiting member 17 is released, and the spring 19 restores its shape, driving the first limiting member 17, the second limiting member 18, and the sixth connecting member 16 to move downward. When the first limiting member 17 contacts an upper end of the fourth connecting member 14, the lower end of the sixth connecting member 16 extends into the connecting hole in the fifth connecting member 15. The sixth connecting member 16 exerts a limiting effect on the fifth connecting member 15 to avoid deviation of the fifth connecting member 15, thereby preventing the first panel 3 and the second panel 6 from rotating. At this time, the first panel 3 and the second panel 6 are in the locked state.

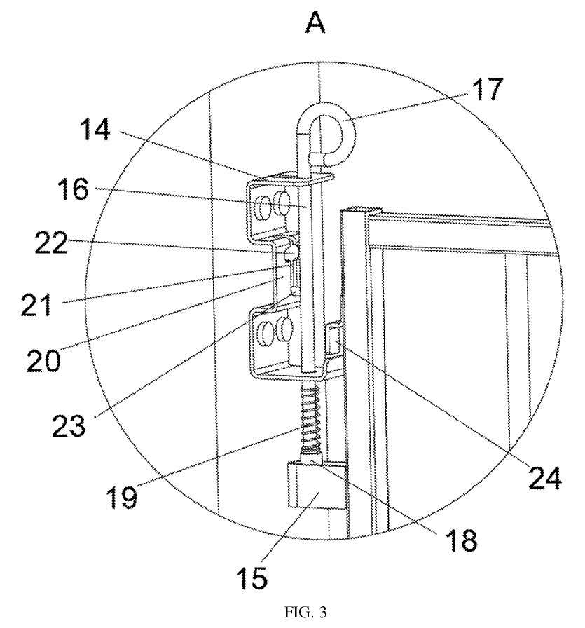

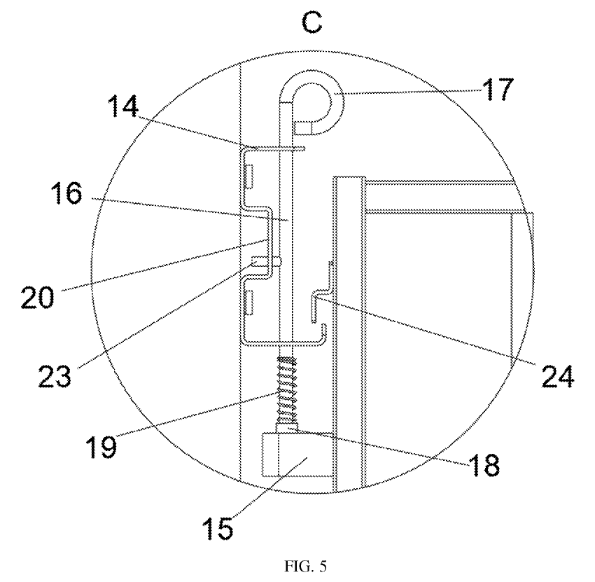

As shown in FIG. 3 and FIG. 5, in an embodiment of the present disclosure, the telescopic pet gate further includes:

a fourth limiting member 24, where the fourth limiting member 24 is fixedly connected to the side of the second panel 6 adjacent to the second vertical rod 2, and the fourth limiting member 24 is disposed inside the fourth connecting member 14.

When a pet's paw is supported on the first panel 3 or the second panel 6, the first panel 3 or the second panel 6 moves downward. Through the design of the fourth limiting member 24, when the first panel 3 or the second panel 6 moves downward, a lower end of the fourth limiting member 24 abuts against an inner bottom of the fourth connecting member 14. The fourth limiting member 24 exerts a limiting effect on the first panel 3 and the second panel 6 to avoid excessive downward movement of the first panel 3 and the second panel 6, thereby avoiding failure of the cooperation between the fifth connecting member 15 and the sixth connecting member 16.

### Embodiment 2

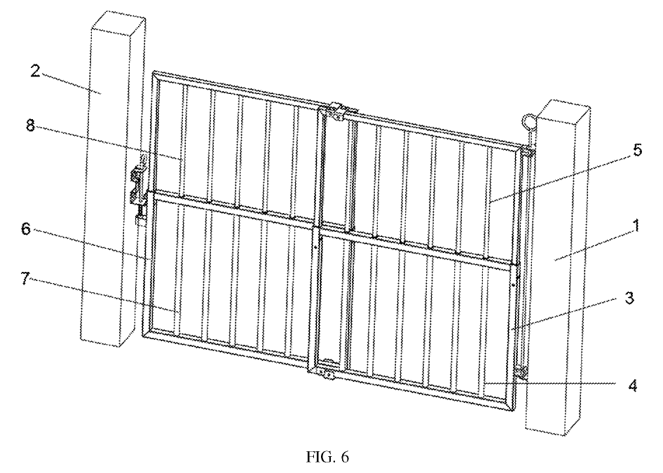

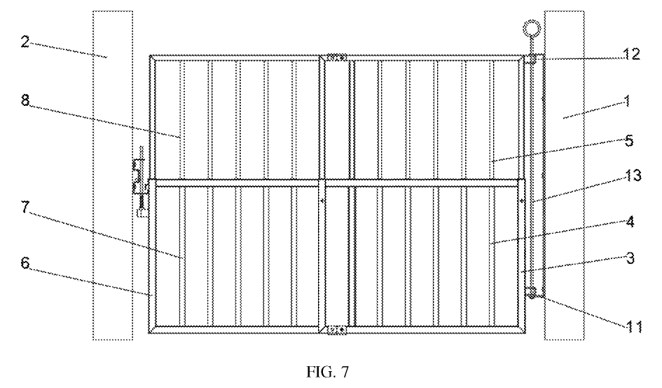

As shown in FIG. 6 and FIG. 7, in an embodiment of the present disclosure, the gate frame includes:

a first vertical rod 1; and

a second vertical rod 2, where the second vertical rod 2 is disposed at a side of the first vertical rod 1, the second vertical rod 2 is parallel to the first vertical rod 1, and the second vertical rod 2 and the first vertical rod 1 are vertically disposed.

The gate panel includes:

a first panel 3, where the first panel 3 is disposed between the first vertical rod 1 and the second vertical rod 2;

a second panel 6, where the second panel 6 is disposed at a side of the first panel 3, the second panel 6 is disposed between the first vertical rod 1 and the second vertical rod 2, the first panel 3 is parallel to the second panel 6, and the first panel 3 and the second panel 6 are not collinear;

first fixing members 9, where the first fixing members 9 are disposed at an upper left end and a lower left end of the first panel 3, respectively, the first fixing members 9 are U-shaped, the first fixing member 9 disposed at the upper left end is provided with an opening facing downward, and the first fixing member 9 disposed at the lower left end is provided with an opening facing upward; and

second fixing members 10, where the second fixing members 10 are disposed at an upper right end and a lower right end of the second panel 6, respectively, the second fixing members 10 are U-shaped, the second fixing member 10 disposed at the upper right end is provided with an opening facing downward, and the second fixing member 10 disposed at the lower right end is provided with an opening facing upward.

The first panel 3 includes:

a first barrier member 4, where the first barrier member 4 includes two first horizontal tubes and two first vertical tubes, the two first vertical tubes are vertically disposed and parallel to each other, the two first horizontal tubes are horizontally disposed and each include two ends fixedly connected to the two first vertical tubes, respectively, a plurality of first metal tubes are fixedly connected between the two first horizontal tubes, and the plurality of first metal tubes are vertically disposed and spaced apart in a left-right direction; and

a second barrier member 5, where the second barrier member 5 includes one second horizontal tube and two second vertical tubes, two ends of the second horizontal tube are fixedly connected to upper ends of the two second vertical tubes, respectively, the two second vertical tubes are slidably connected in the two first vertical tubes, respectively, lower surfaces of the second vertical tubes are fixedly connected to upper ends of a plurality of second metal tubes, respectively, lower ends of the plurality of second metal tubes pass through an upper first horizontal tube, and the plurality of second metal tubes are slidably connected in the plurality of first metal tubes, respectively.

The second panel 6 includes:

a third barrier member 7, where the third barrier member 7 includes two third horizontal tubes and two third vertical tubes, the two third vertical tubes are vertically disposed and parallel to each other, the two third horizontal tubes are horizontally disposed and each include two ends fixedly connected to the two third vertical tubes, respectively, a plurality of third metal tubes are fixedly connected between the two third horizontal tubes, and the plurality of third metal tubes are vertically disposed and spaced apart in the left-right direction; and

a fourth barrier member 8, where the fourth barrier member 8 includes one fourth horizontal tube and two fourth vertical tubes, two ends of the fourth horizontal tube are fixedly connected to upper ends of the two fourth vertical tubes, respectively, the two fourth vertical tubes are slidably connected in the two third vertical tubes, respectively, lower surfaces of the fourth vertical tubes are fixedly connected to upper ends of a plurality of fourth metal tubes, respectively, lower ends of the plurality of fourth metal tubes pass through an upper third horizontal tube, and the plurality of fourth metal tubes are slidably connected in the plurality of third metal tubes, respectively.

When the mounting of the entire structure starts, the distance between the first vertical rod 1 and the second vertical rod 2 is first determined according to the width of the doorway. Then the first vertical rod 1 and the second vertical rod 2 are pulled towards two sides. When the first vertical rod 1 and the second vertical rod 2 are pulled, since the connection assembly connects the first vertical rod 1 to the first panel 3, the first vertical rod 1 drives the first panel 3 to move to the right. Since the second vertical rod 2 is connected to the second panel 6 through the locking assembly, the second vertical rod 2 drives the second panel 6 to move to the left. Thus, through the movement of the first panel 3 and the second panel 6, the entire gate panel can meet the mounting requirement. When the positions of the first vertical rod 1 and the second vertical rod 2 are determined, the first panel 3 and the second panel 6 stop moving.

The first fixing members 9 are respectively disposed at a left end of the second horizontal tube and a left end of the first horizontal tube below in the first panel 3. With the opening facing downward, the first fixing member 9 on the second horizontal tube hangs downward on the left end of the second horizontal tube and on the fourth horizontal tube. The second horizontal tube and the fourth horizontal tube are disposed inside the opening of the first fixing member 9. A side of the first fixing member 9 adjacent to the first horizontal tube is provided with a threaded hole. A screw is threadedly connected in the threaded hole, and an end of the screw abuts against the left end of the second horizontal tube. The screw is continuously tightened to make the second horizontal tube closely attached to the fourth horizontal tube and the fourth horizontal tube closely attached to an inner wall of the first fixing member 9, thereby fixing the first panel 3 and the second panel 6 and avoiding relative movement between the first panel 3 and the second panel 6. The opening of the first fixing member 9 faces upward, and a left end of a lower first horizontal tube and a third horizontal tube are disposed inside the opening of the first fixing member 9. A side of the first fixing member 9 adjacent to the first horizontal tube is provided with a threaded hole. A screw is threadedly connected in the threaded hole, and an end of the screw abuts against the left end of the first horizontal tube. The screw is continuously tightened to make the first horizontal tube closely attached to the third horizontal tube and the third horizontal tube closely attached to an inner wall of the first fixing member 9, thereby fixing the first panel 3 and the second panel 6 and avoiding relative movement between the first panel 3 and the second panel 6.

The second fixing members 10 are respectively disposed at a right end of the fourth horizontal tube and a right end of the third horizontal tube below in the second panel 6. With the opening facing downward, the second fixing members 10 on the fourth horizontal tube hangs downward on the right end of the fourth horizontal tube and on the second horizontal tube. The right end of the fourth horizontal tube and the second horizontal tube are disposed inside the opening of the first fixing member 9. A side of the second fixing member 10 adjacent to the fourth horizontal tube is provided with a threaded hole. A screw is threadedly connected in the threaded hole, and an end of the screw abuts against the right end of the fourth horizontal tube. The screw is continuously tightened to make the fourth horizontal tube closely attached to the second horizontal tube and the second horizontal tube closely attached to an inner wall of the second fixing member 10, thereby fixing the second panel 6 and the first panel 3 and avoiding relative movement between the second panel 6 and the first panel 3. The opening of the second fixing member 10 disposed at the lower right end faces upward, and a right end of a lower third horizontal tube and a lower first horizontal tube are disposed inside the opening of the second fixing member 10. A side of the second fixing member 10 adjacent to the third horizontal tube is provided with a threaded hole. A screw is threadedly connected in the threaded hole, and an end of the screw abuts against the right end of the third horizontal tube. The screw is continuously tightened to make the third horizontal tube closely attached to the first horizontal tube and the first horizontal tube closely attached to the inner wall of the second fixing member 10, thereby fixing the first panel 3 and the second panel 6 and avoiding relative movement between the first panel 3 and the second panel 6.

Through the design of the first panel 3 and the second panel 6, the gate panel formed by the first panel 3 and the second panel 6 is applicable to doorways of different widths, which expands the application range of the entire structure. The positions of the first panel 3 and the second panel 6 are fixed by the two first fixing members 9 and the two second fixing members 10, thereby avoiding relative deviation between the first panel 3 and the second panel 6.

In addition, the second metal tube is slidably connected in the first metal tube, the fourth metal tube is slidably connected in the third metal tube, the second vertical tube is slidably connected in the first vertical tube, and the fourth vertical tube is slidably connected in the third vertical tube. In this way, the first panel 3 and the second panel 6 are vertically telescopic. This allows for a reduction in the volume of the first panel 3 and the second panel 6 when the entire device is disassembled, thereby improving space utilization.

As shown in FIG. 6 and FIG. 7, in an embodiment of the present disclosure, the connection assembly includes:

a first connecting member 11, where the first connecting member 11 is fixedly connected to a side of the first vertical rod 1 adjacent to the second vertical rod 2;

a second connecting member 12, where the second connecting member 12 is fixedly connected to a side of the first panel 3 adjacent to the first vertical rod 1, that is, the second connecting member 12 is fixedly connected to the first vertical tube and the second vertical tube on a right side of the first panel 3, and the second connecting member 12 disposed on the second vertical tube on the right side is disposed at a top of the second vertical tube to ensure that the second vertical tube can fully enter the first vertical tube; and

a third connecting member 13, where the third connecting member 13 passes through the first connecting member 11 and the second connecting member 12, the third connecting member 13 is rotatably connected to the first connecting member 11 and the second connecting member 12, and the third connecting member 13 is vertically disposed.

When the first panel 3 needs to be connected to the first vertical rod 1, the third connecting member 13 is passed through the first connecting member 11 and the second connecting member 12. Then a nut is threadedly connected to a bottom of the third connecting member 13. When the nut contacts the first connecting member 11, the connection of the first connecting member 11, the second connecting member 12, and the third connecting member 13 is completed. The first connecting member 11 and the third connecting member 13 are relatively fixed, and the second connecting member 12 is rotatable around the third connecting member 13 as an axis.

As shown in FIG. 3 and FIG. 5, in an embodiment of the present disclosure, the locking assembly includes:

a fourth connecting member 14, where the fourth connecting member 14 is fixedly connected to a side of the second vertical rod 2 adjacent to the first vertical rod 1, the fourth connecting member 14 is U-shaped, and the fourth connecting member 14 is provided with an opening facing the first vertical rod 1;

a fifth connecting member 15, where the fifth connecting member 15 is fixedly connected to a side of the second panel 6 adjacent to the second vertical rod 2, that is, the fifth connecting member 15 is fixedly connected to the third vertical tube on a left side of the second panel 6, and the fifth connecting member 15 is provided with a connecting hole in a vertical direction;

a sixth connecting member 16, where the sixth connecting member 16 is disposed between the second panel 6 and the second vertical rod 2, and the sixth connecting member 16 passes through the fourth connecting member 14 and the fifth connecting member 15;

a first limiting member 17, where the first limiting member 17 is connected to an upper end of the sixth connecting member 16;

a second limiting member 18, where the second limiting member 18 is connected to a lower end of the sixth connecting member 16; and

a spring 19, where the spring 19 is sleeved outside the sixth connecting member 16, and the spring 19 is disposed between the second limiting member 18 and the fourth connecting member 14.

The telescopic pet gate further includes:

a protruding portion 20, where the protruding portion 20 is disposed at a bottom of the opening of the fourth connecting member 14, the protruding portion 20 is provided with a sliding groove 21 in the vertical direction, the protruding portion 20 is provided with a limiting hole 22, and the limiting hole 22 is connected to the sliding groove 21; and

a third limiting member 23, where the third limiting member 23 is fixedly connected to the sixth connecting member 16, and the third limiting member 23 is slidably connected in the sliding groove 21.

When the gate panel needs to be opened, the first limiting member 17 is pulled upward. The first limiting member 17 drives the sixth connecting member 16, the second limiting member 18, and the third limiting member 23 to move upward, and the third limiting member 23 moves upward along the sliding groove 21. Meanwhile, when the first limiting member 17 is pulled, since the fourth connecting member 14 is fixed and the second limiting member 18 moves upward, the second limiting member 18 compresses the spring 19. When the second limiting member 18 moves to a position above the fifth connecting member 15 and the third limiting member 23 moves to a position at the same height as the limiting hole 22, the fifth connecting member 15 and the sixth connecting member 16 no longer cooperate with each other. Then the first limiting member 17 is rotated, and the first limiting member 17 drives the third limiting member 23 to move, such that the third limiting member 23 moves into the limiting hole 22. Then the first limiting member 17 is released. Through the cooperation between the third limiting member 23 and the limiting hole 22, the sixth connecting member 16 is fixed, thereby preventing the sixth connecting member 16 from moving downward. Then the first panel 3 or the second panel 6 is pushed to open the gate panel.

When the gate panel needs to be locked, the first panel 3 and the second panel 6 are pushed back to their initial positions. Then the first limiting member 17 is rotated to make the third limiting member 23 slide out of the limiting hole 22. Then the first limiting member 17 is released, and the spring 19 restores its shape, driving the first limiting member 17, the second limiting member 18, and the sixth connecting member 16 to move downward. When the first limiting member 17 contacts an upper end of the fourth connecting member 14, the lower end of the sixth connecting member 16 extends into the connecting hole in the fifth connecting member 15. The sixth connecting member 16 exerts a limiting effect on the fifth connecting member 15 to avoid deviation of the fifth connecting member 15, thereby preventing the first panel 3 and the second panel 6 from rotating. At this time, the first panel 3 and the second panel 6 are in the locked state.

As shown in FIG. 3 and FIG. 5, in an embodiment of the present disclosure, the telescopic pet gate further includes:

a fourth limiting member 24, where the fourth limiting member 24 is fixedly connected to the side of the second panel 6 adjacent to the second vertical rod 2, that is, the fourth limiting member 24 is fixedly connected to the third vertical tube on the left side of the second panel 6, and the fourth limiting member 24 is disposed inside the fourth connecting member 14.

When a pet's paw is supported on the first panel 3 or the second panel 6, the first panel 3 or the second panel 6 moves downward. Through the design of the fourth limiting member 24, when the first panel 3 or the second panel 6 moves downward, a lower end of the fourth limiting member 24 abuts against an inner bottom of the fourth connecting member 14. The fourth limiting member 24 exerts a limiting effect on the first panel 3 and the second panel 6 to avoid excessive downward movement of the first panel 3 and the second panel 6, thereby avoiding failure of the cooperation between the fifth connecting member 15 and the sixth connecting member 16.

The present disclosure has the following advantages:
1. By configuring the gate panel as a telescopic structure, the widths of the gate frame and the gate panel can be extended to accommodate doorways of different widths, thereby improving the practicality of the entire device.
2. By disposing the locking assembly between the gate frame and the gate panel, the locking assembly can move vertically to open and lock the gate panel, achieving simple operation.
3. By disposing the connection assembly between the gate frame and the gate panel, the connection assembly can connect the gate frame to the gate panel. In addition, when the entire device needs to be disassembled and transported, the connection assembly can be removed to separate the gate frame from the gate panel, reducing the difficulty in transporting the entire device.
4. The gate panel is vertically telescopic, which can reduce the volume of the gate panel and improve space utilization during storage or transportation.

In the present disclosure, the terms such as "provided", "connected to", "connected", and "fixed" should be comprehended in a broad sense. For example, "connected" may be comprehended as fixedly connected, detachably connected, or integrally connected, and "connected to" may be directly connected to or indirectly connected to through an intermediary. Those of ordinary skill in the art may understand the specific meanings of the above terms in the present disclosure based on specific situations.

In the description of the present disclosure, it should be understood that orientation or position relationships indicated by terms such as "inside" and "outside" are orientation or position relationships shown in the drawings, and these terms are just used to facilitate description of the present disclosure and simplify the description, but not to indicate or imply that the mentioned apparatus or elements must have a specific orientation and must be constructed and operated in a specific orientation, and thus, these terms cannot be understood as a limitation to the present disclosure.

In the description of this specification, the description with reference to the terms such as ''one embodiment'', ''some embodiments'', and ''a specific embodiment'' means that the specific features, structures, materials, or characteristics described with reference to the embodiment or example are included in at least one embodiment or example of the present disclosure. In this specification, the schematic descriptions of the above terms do not necessarily refer to the same embodiment or example. Moreover, the specific features, structures, materials, or characteristics described may be combined in any suitable manner in any one or more embodiments or examples.

The above are merely preferred embodiments of the present disclosure, and are not intended to limit the present disclosure, and various changes and modifications can be made by those skilled in the art to the present disclosure. Any modifications, equivalent substitutions, improvements, etc. made within the spirit and principle of the present disclosure should be included in the protection scope of the present disclosure.

What is claimed is:

1. A telescopic pet gate, comprising:
a gate frame;
a gate panel, wherein the gate panel is disposed inside the gate frame;
a connection assembly, wherein the connection assembly is connected to a first end of the gate panel and to the gate frame; and
a locking assembly, wherein the locking assembly is connected to a second end of the gate panel and to the gate frame.

2. The telescopic pet gate according to claim 1, wherein
the gate frame comprises:
a first vertical rod; and
a second vertical rod, wherein the second vertical rod is disposed at a side of the first vertical rod, and the second vertical rod is parallel to the first vertical rod.

3. The telescopic pet gate according to claim 2, wherein
the gate panel comprises:
a first panel, wherein the first panel is disposed between the first vertical rod and the second vertical rod;
a second panel, wherein the second panel is disposed at a first side of the first panel, and the second panel is disposed between the first vertical rod and the second vertical rod;
a first fixing member, wherein the first fixing member is connected to at least one of an upper end or a lower end of the first panel, and the first fixing member is U-shaped; and
a second fixing member, wherein the second fixing member is connected to at least one of an upper end or a lower end of the second panel, and the second fixing member is U-shaped.

4. The telescopic pet gate according to claim 3, wherein
the first panel comprises:
a first barrier member; and
a second barrier member, wherein the second barrier member is slidably connected in the first barrier member; and
the second panel comprises:
a third barrier member; and
a fourth barrier member, wherein the fourth barrier member is slidably connected in the third barrier member.

5. The telescopic pet gate according to claim 3, wherein
the connection assembly comprises:
a first connecting member, wherein the first connecting member is connected to the side of the first vertical rod adjacent to the second vertical rod;
a second connecting member, wherein the second connecting member is connected to a second side of the first panel adjacent to the first vertical rod; and
a third connecting member, wherein the third connecting member passes through the first connecting member and the second connecting member, and the third connecting member is rotatably connected to the first connecting member and the second connecting member.

6. The telescopic pet gate according to claim 5, wherein
the locking assembly comprises:
a fourth connecting member, wherein the fourth connecting member is connected to a side of the second vertical rod adjacent to the first vertical rod, the fourth connecting member is U-shaped, and the fourth connecting member is provided with an opening facing the first vertical rod;
a fifth connecting member, wherein the fifth connecting member is connected to a side of the second panel adjacent to the second vertical rod;
a sixth connecting member, wherein the sixth connecting member is disposed between the second panel and the second vertical rod, and the sixth connecting member passes through the fourth connecting member and the fifth connecting member;
a first limiting member, wherein the first limiting member is connected to a first end of the sixth connecting member;
a second limiting member, wherein the second limiting member is connected to a second end of the sixth connecting member; and
a spring, wherein the spring is sleeved outside the sixth connecting member, and the spring is disposed between the second limiting member and the fourth connecting member.

7. The telescopic pet gate according to claim 6, further comprising:
a protruding portion, wherein the protruding portion is disposed at a bottom of the opening of the fourth connecting member, the protruding portion is provided with a sliding groove, the protruding portion is provided with a limiting hole, and the limiting hole is connected to the sliding groove; and
a third limiting member, wherein the third limiting member is connected to the sixth connecting member, and the third limiting member is slidably connected in the sliding groove.

8. The telescopic pet gate according to claim 7, further comprising:
a fourth limiting member, wherein the fourth limiting member is connected to the side of the second panel adjacent to the second vertical rod, and the fourth limiting member is disposed inside the fourth connecting member.
